(19) United States
(12) Patent Application Publication
(10) Pub. No.: US 2006/0110157 A1
(43) Pub. Date: May 25, 2006

(54) Transceiver with interrupt unit

(75) Inventors: Georg S. Tritschler, Longmont, CO (US); Heike Grimm, Longmont, CO (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: Infineon Technologies North America Corp.

(21) Appl. No.: 10/994,964

(22) Filed: Nov. 22, 2004

(51) Int. Cl. H04B 10/08

(52) U.S. Cl. 398/22

(57) ABSTRACT

A transceiver comprising a memory and an interrupt unit configured to store interrupt information in the memory and generate an interrupt in response to a parameter exceeding an operating limit is provided. The interrupt unit is configured to provide the interrupt to the host using an output signal to cause the host to access the interrupt information.

### BACKGROUND

Transceivers and other data communication devices are typically configured to communicate with a host by transmitting and receiving information across a wired or wireless medium using a signaling protocol. Transceivers may be designed to conform to one or more industry standards. Such industry standards may specify physical, electrical, and/or mechanical criteria for devices such as transceivers. An industry standard may also describe methods of communicating or performing operations with other devices that comply with standard. In order to conform or comply with a standard, a device typically meets all of the called for physical, mechanical, and/or electrical provisions.

One organization that has been formed to set standards that apply to transceivers is the Small Form Factor (SFF) Committee. The SFF committee may be found at http://www.sffcommittee.com. One set of standards set forth by the Committee includes standards for small form factor pluggable (SFP) transceivers. These standards include the Small Form Factor Pluggable Transceiver MultiSource Agreement (SFP MSA) the SFF-8074i Specification for SFP (Small Form Factor Pluggable) Transceiver, and the SFF-8472 Specification for Digital Diagnostic Monitoring Interface for Optical Transceivers. Unfortunately, these standards do not provide a way for a transceiver to provide real-time diagnostic information to a host.

It would be desirable for a transceiver to be able to provide real-time diagnostic information to a host while maintaining compliance with industry standards for the transceiver.

### SUMMARY

According to one exemplary embodiment, a transceiver comprising a memory and an interrupt unit configured to store interrupt information in the memory and generate an interrupt in response to a parameter exceeding an operating limit is provided. The interrupt unit is configured to provide the interrupt to the host using an output signal to cause the host to access the interrupt information.

### BRIEF DESCRIPTION OF THE DRAWINGS

FIG. 1 is a block diagram illustrating one embodiment of a system that comprises a transceiver and a host.

FIG. 2 is a flow chart illustrating one embodiment of a method for providing real-time diagnostic information to a host.

FIG. 3 is a schematic diagram illustrating a first embodiment of an interrupt unit.

FIG. 4 is a schematic diagram illustrating a second embodiment of an interrupt unit.

FIG. 5 is a schematic diagram illustrating a third embodiment of an interrupt unit.

FIG. 6 is a schematic diagram illustrating a fourth embodiment of an interrupt unit.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

According to one embodiment, a transceiver with an interrupt unit is provided. In response to detecting a parameter that exceeds an operating limit in a transceiver, the transceiver stores interrupt information in a memory and provides an interrupt to a host using an output signal. More particularly, the transceiver provides the interrupt on an output signal that is defined for a purpose other than an interrupt signal according to an industry standard or other specification. The host detects the interrupt signal and accesses the interrupt information to identify a problem with the transceiver.

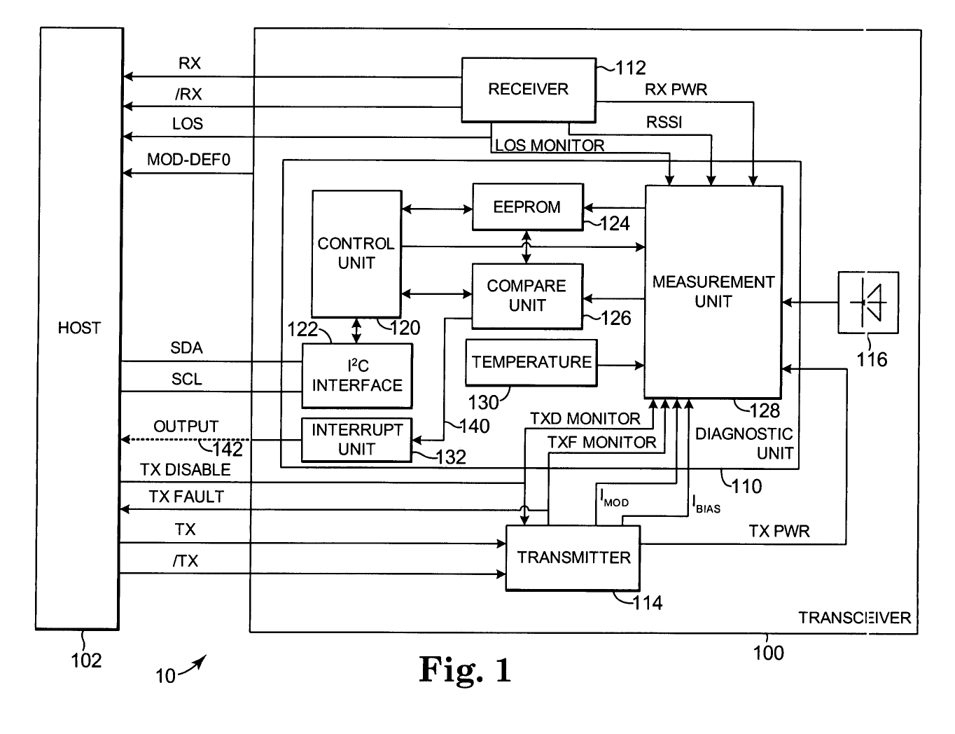

FIG. 1 is a block diagram illustrating one embodiment of a system 10 that comprises a transceiver 100 and a host 102. Transceiver 100 comprises a diagnostic unit 110, a receiver 112, a transmitter 114, and an external sensor interface 116. Diagnostic unit 110 comprises a control unit 120, an I²C interface 122, an EEPROM 124, a compare unit 126, a measurement unit 128, a temperature sensor 130, and interrupt unit 132.

Transceiver 100 communicates with host 102 by sending and receiving optical and/or electrical signals as described in additional detail herein below. In one embodiment, transceiver 100 comprises a Fibre Channel transceiver configured to communicate according to a Fibre Channel protocol. In other embodiments, transceiver 100 comprises a Gigabit Ethernet transceiver configured to communicate according to a Gigabit Ethernet protocol or another type of transceiver configured to communicate according to another type of protocol.

In one embodiment, transceiver 100 complies with the Small Form Factor Pluggable Transceiver MultiSource Agreement (SFP MSA), the SFF-8074i Specification for SFP (Small Form Factor Pluggable) Transceiver, and the SFF-8472 Specification for Digital Diagnostic Monitoring Interface for Optical Transceivers. The SFP MSA, the SFF-8074i specification, and the SFF-8472 specification are available from http://www.sffcommittee.com or ftp://ftp.seagate.com/sff/. In other embodiments, transceiver 100 may conform to other industry specifications or industry standards.

Host 102 may be any type of wired or wireless device configured to operate in conjunction with transceiver 100. Host 102 is external to transceiver 100. Examples of such devices include a test system, a server computer system, a personal computer system, a laptop computer system, a handheld computer system, a personal digital assistant, a mobile telephone, and a storage device or system.

In operation, receiver 112 provides digital output signals to host 102 using a receive data signal RX and an inverted receive data signal /RX. Receiver 112 generates a loss of signal (LOS) signal associated with the digital output signals from host 102 and provides the LOS signal to host 102 and measurement unit 128. Receiver 112 also generates an receive signal strength indicator (RSSI) signal or a receiver power signal (RX PWR) and provides the RSSI or RX PWR signals to measurement unit 128.

Transmitter 114 receives digital output signals from host 102 using a transmit data signal TX and an inverted transmit data signal /TX. Transmitter 114 receives a transmit disable signal (TX DISABLE) from host 102. Transmitter 114 generates a transmit fault signal (TX FAULT) and provides the TX FAULT signal to host 102 and measurement unit 128. Transmitter 114 also generates a transmit power signal (TX PWR), a modulation current signal (I_{MOD}), and a bias current signal (I_{BIAS}) and provides the TX PWR, I_{MOD}, and I_{BIAS} signals to measurement unit 128.

External sensor interface 116 receives an input signal from an external sensor and provides the input signal to measurement unit 128.

Diagnostic unit 110 receives diagnostic information, such as diagnostic parameters, from receiver 112, transmitter 114, an external sensor connected to external sensor interface 116, temperature unit 130, and other components of transceiver 100 (not shown) and stores the diagnostic information in EEPROM 124. Host 102 accesses diagnostic information from diagnostic unit 110 using a serial data line signal (SDA) and a serial clock line signal (SCL). The SDA and SCL signals comprise an I²C connection. In particular, host 102 polls diagnostic unit 110 using I²C interface 122 to determine when to the diagnostic information is available in EEPROM 124. In addition, host 102 also accesses diagnostic information from EEPROM 124 in response to receiving an interrupt on an output signal as described in additional detail below. Control unit 120 manages the operation of I²C interface 122, EEPROM 124, compare unit 126, measurement unit 128, and temperature unit 130 using control signals.

Measurement unit 128 receives diagnostic parameters from receiver 112, transmitter 114, an external sensor connected to external sensor interface 116, temperature unit 130 and other components of transceiver 100 (not shown). The diagnostic parameters may be received by measurement unit 128 in an analog format and may be converted by measurement unit 128 to a digital format in certain embodiments. For example, measurement unit 128 receives a voltage parameter and a receive power parameter from receiver 112, a bias current parameter, a modulation current parameter, and a transmit power parameter from transmitter 114, and a temperature parameter from temperature unit 130. Measurement unit 128 provides the diagnostic parameters to compare unit 126 and stores the diagnostic parameters and/or other results in EEPROM 124 as specified by SFF-8472.

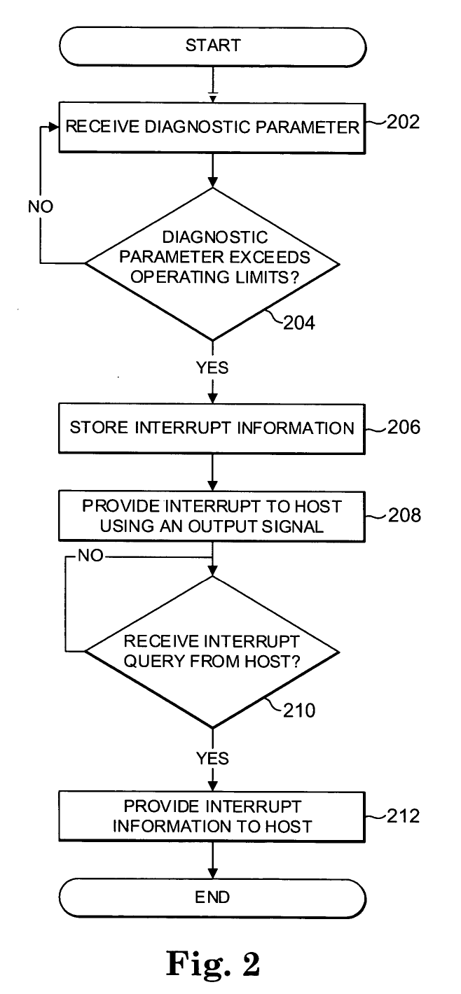

FIG. 2 is a flow chart illustrating one embodiment of a method for providing real-time diagnostic information from transceiver 100 to host 102. A diagnostic parameter is received by compare unit 126 as indicated in a block 202. A determination is made by compare unit 126 to detect whether the diagnostic parameter exceeds operating limits as indicated in a block 204. In particular, compare unit 126 compares the diagnostic parameter to one or more ranges or threshold values stored in EEPROM 124 to determine whether the diagnostic parameter exceeds one or more operating limits. If the diagnostic parameter does not exceed one or more operating limits, then the functions blocks 202 and 204 are repeated at a later time.

If the diagnostic parameter exceeds one or more operating limits, then compare unit 126 causes interrupt information associated with the diagnostic parameter to be stored in EEPROM 124 as indicated in a block 206. The interrupt information identifies the type of diagnostic parameter. For example, the interrupt information may indicate that temperature, voltage, bias current, modulation current, receive power, or transmit power of transceiver 100 are exceed operating limits. The interrupt information may also identify the operating limit that is exceeded, e.g., high temperature or low temperature, and specify whether the operating limit that is exceeded is a warning limit or an alarm limit, e.g., high voltage warning or high voltage alarm.

Compare unit 126 also causes an interrupt to be provided to host 102 using an output signal 142 as indicated in a block 208. Output signal 142 comprises an output signal that is defined for a purpose other than as an interrupt signal according to an industry specification such as the SFP MSA. Compare unit 126 provides a signal 140 to interrupt unit 132 to cause the interrupt to be provided to host 102. Interrupt unit 132 receives the interrupt signal from compare unit 126 and provides an interrupt to host 102 using output signal 142. Embodiments of interrupt unit 132 are illustrated in FIGS. 3, 4, 5, and 6 and described in additional detail below.

A determination is made by diagnostic unit 110 as to whether an interrupt query associated with the interrupt has been received from host 102 as indicated in a block 210. Host 102 provides the interrupt query using I²C interface 122. If an interrupt query associated with the interrupt has been received from host 102, then diagnostic unit 110 provides the interrupt information associated with the interrupt from EEPROM 124 to host 102 using I²C interface 122.

In certain embodiments, one or more interrupts may be programmed to be enabled, disabled, or masked by storing information associated with the interrupts in EEPROM 124. In these embodiments, compare unit 126 receives this information to determine whether an interrupt should be generated in response to receiving a diagnostic parameter.

As shown in the embodiments of FIGS. 3, 4, 5, and 6, output signal 142 used for providing the interrupt to host 102 may comprise the LOS signal, the module definition 0 signal (MOD-DEF0), the TX FAULT signal, or the SDA and SCL signals as defined by the SFP MSA. Each of these signals is defined by the SFP MSA for a purpose other than providing interrupts from transceiver 100 to host 102.

FIG. 3 is a schematic diagram illustrating a first embodiment of an interrupt unit 132A. In the embodiment of FIG. 3, output signal 142 comprises LOS signal 142A. According to the SFP MSA, LOS signal 142A, i.e., pin 8, is provided from transceiver 100 to host 102 to indicate a loss of the RX and/or /RX signals. In particular, receiver 112 causes a first logic level, i.e., a low or ground voltage, to be provided to host 102 on LOS signal 142A in the normal operation of transceiver 100 and causes a second logic level, i.e., a high voltage, to be provided to host 102 on LOS signal 142A to indicate a loss of the RX and/or /RX signals.

In the embodiment shown in FIG. 3, receiver 112 provides either the first logic level or the second logic level to OR logic 302. Compare unit 126 also provides either a first logic level or a second logic level to OR logic 302 using signal 140 where the second logic level indicates that an interrupt is to be provided to host 102. In response to receiving the second logic level from compare unit 126, OR logic 302 provides an interrupt to host 102 by pulling LOS signal 142A to the second logic level.

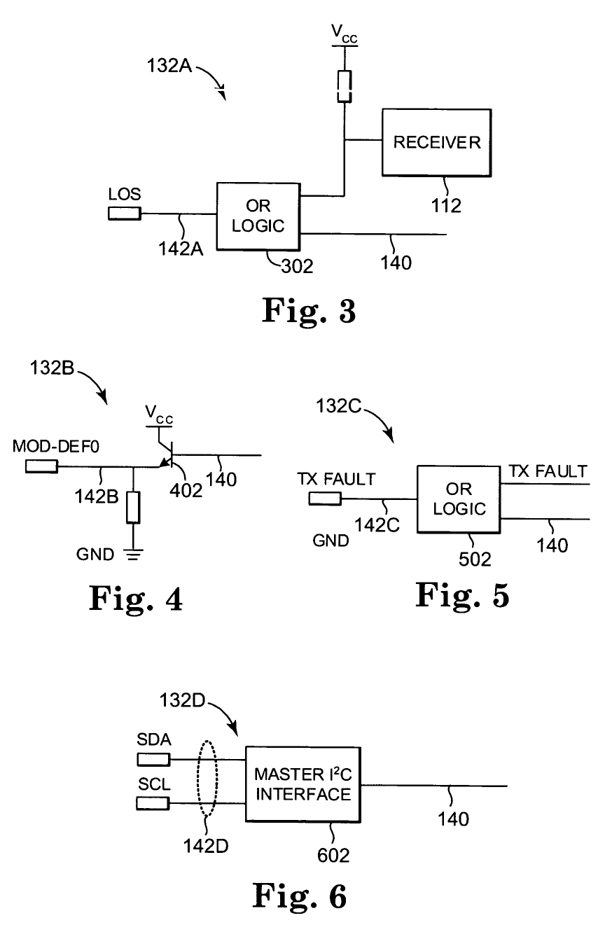

FIG. 4 is a schematic diagram illustrating a second embodiment of interrupt unit 132B. In the embodiment of FIG. 4, output signal 142 comprises MOD-DEF0 signal 142B. According to the SFP MSA, MOD-DEF0 signal 142B, i.e., pin 6, is grounded to indicate to host 102 that transceiver 100 is present. In particular, transceiver 100 causes a first logic level, i.e., a low or ground voltage, to be provided to host 102 on MOD-DEF0 signal 142B in normal operation of transceiver 100.

In the embodiment shown in FIG. 4, compare unit 126 provides either a first logic level or a second logic level to the base of transistor 402 using signal 140 where the second logic level indicates that an interrupt is to be provided to host 102. In response to receiving the second logic level from compare unit 126, transistor 402 provides an interrupt to host 102 by pulling MOD-DEF0 signal 142B to the second logic level.

FIG. 5 is a schematic diagram illustrating a third embodiment of interrupt unit 132C. In the embodiment of FIG. 5, output signal 142 comprises TX FAULT signal 142C. According to the SFP MSA, TX FAULT signal 142C, i.e., pin 2, is provided from transceiver 100 to host 102 to indicate a transmitter fault. In particular, transmitter 114 causes a first logic level, i.e., a low or ground voltage, to be provided to host 102 on TX FAULT signal 142C in the normal operation of transceiver 100 and causes a second logic level, i.e., a high voltage, to be provided to host 102 on TX FAULT signal 142C to indicate a transmitter fault.

In the embodiment shown in FIG. 5, transmitter 114 provides either the first logic level or the second logic level to OR logic 502. Compare unit 126 also provides either a first logic level or a second logic level to OR logic 502 using signal 140 where the second logic level indicates that an interrupt is to be provided to host 102. In response to receiving the second logic level from compare unit 126, OR logic 302 causes an interrupt to be provided to host 102 by pulling TX FAULT signal 142C to the second logic level.

FIG. 6 is a schematic diagram illustrating a fourth embodiment of interrupt unit 132D. Interrupt unit 132D comprises a master I²C interface 602, and output signal 142 comprises SDA signal and SCL signal 142D in this embodiment. By including master I²C interface 602, transceiver 100 operates as an I²C master device to allow transceiver 100 to transmit interrupts.

Compare unit 126 provides either a first logic level or a second logic level to master I²C interface 602 using signal 140 where the second logic level indicates that an interrupt is to be provided to host 102. In response to receiving the second logic level from compare unit 126, master I²C interface 602 provides an interrupt to host 102 using SDA signal and SCL signal 142D.

The components of transceiver 100 described herein may each be implemented using hardware, software, or a combination of hardware and software. Although shown in diagnostic unit 110 in the embodiment of FIG. 1, measurement unit 128, compare unit 126, temperature unit 130, and interrupt unit 132 may be implemented in other portions of transceiver 100 in other embodiments. In other embodiments, EEPROM 134 may be replaced by another type of memory or storage device or an external memory or storage device in other embodiments.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A transceiver comprising:
a memory; and
an interrupt unit configured to store interrupt information in the memory and generate an interrupt in response to a parameter exceeding an operating limit, the interrupt unit configured to provide the interrupt to the host using an output signal to cause the host to access the interrupt information.

2. The transceiver of claim 1 wherein the output signal is defined by an industry standard for a purpose other than providing the interrupt to the host.

3. The transceiver of claim 2 wherein the industry standard comprises the Small Form Factor Pluggable Transceiver MultiSource Agreement (SFP MSA).

4. The transceiver of claim 3 wherein the output signal is selected from the group consisting of a loss of signal (LOS) signal, a module definition 0 (MOD-DEF0) signal, a transmit fault (TX FAULT) signal, and serial data line (SDA) and serial clock line (SCL) signals.

5. The transceiver of claim 1 further comprising:
a diagnostic unit configured to detect that the parameter exceeds the operating limit.

6. The transceiver of claim 5 wherein the diagnostic unit comprises the interrupt unit.

7. The transceiver of claim 5 further comprising:
a transmitter configured to provide the parameter to the diagnostic unit.

8. The transceiver of claim 5 further comprising:
a receiver configured to provide the parameter to the diagnostic unit.

9. The transceiver of claim 5 further comprising:
an external signal interface configured to provide the parameter to the diagnostic unit.

10. The transceiver of claim 5 further comprising:
a temperature sensor configured to provide the parameter to the diagnostic unit.

11. The transceiver of claim 1 wherein the parameter is selected from the group consisting of a temperature parameter, a voltage parameter, a receive power parameter, a transmit power parameter, a bias current parameter, and a modulation current parameter.

12. A method comprising:
determining that a parameter exceeds an operating limit in a transceiver;
storing interrupt information associated with the parameter in the transceiver; and
providing an interrupt associated with the parameter to a host coupled to the transceiver using an output signal to cause the host to access the interrupt information.

13. The method of claim 12 further comprising:
detecting the parameter in the transceiver.

14. The method of claim 12 further comprising:
receiving the parameter from a sensor coupled to the transceiver.

15. The method of claim 12 wherein the output signal is defined by an industry standard for a purpose other than providing the interrupt to the host.

16. The method of claim 15 wherein the industry standard comprises the Small Form Factor Pluggable Transceiver MultiSource Agreement (SFP MSA).

17. The method of claim 16 wherein the output signal is selected from the group consisting of a loss of signal (LOS) signal, a module definition 0 (MOD-DEF0) signal, a transmit fault (TX FAULT) signal, and serial data line (SDA) and serial clock line (SCL) signals.

18. The method of claim 12 wherein the parameter is selected from the group consisting of a temperature parameter, a voltage parameter, a receive power parameter, a transmit power parameter, a bias current parameter, and a modulation current parameter.

19. A transceiver comprising:
means for determining that the parameter exceeds an operating limit in a transceiver;
means for storing interrupt information associated with the parameter in the transceiver; and
means for providing an interrupt associated with the parameter to a host coupled to the transceiver using an output signal to cause the host to access the interrupt information.

20. The transceiver of claim 19 further comprising:
means for detecting the parameter in the transceiver.

21. The transceiver of claim 19 further comprising:
means for receiving the parameter from a sensor coupled to the transceiver.

22. The transceiver of claim 19 wherein the output signal is defined by an industry standard for a purpose other than providing the interrupt to the host.

23. The transceiver of claim 22 wherein the industry standard comprises the Small Form Factor Pluggable Transceiver MultiSource Agreement (SFP MSA).

24. The transceiver of claim 23 wherein the output signal is selected from the group consisting of a loss of signal (LOS) signal, a module definition 0 (MOD-DEF0) signal, a transmit fault (TX FAULT) signal, and serial data line (SDA) and serial clock line (SCL) signals.

25. The transceiver of claim 19 wherein the parameter is selected from the group consisting of a temperature parameter, a voltage parameter, a receive power parameter, a transmit power parameter, a bias current parameter, and a modulation current parameter.
